(19) United States
(12) Patent Application Publication
(10) Pub. No.: US 2022/0112050 A1
(43) Pub. Date: Apr. 14, 2022

(54) ELEVATOR SYSTEM FLOOR HEIGHT MAPPING

(71) Applicant: Otis Elevator Company, Farmington, CT (US)

(72) Inventor: Nikola Trcka, West Hartford, CT (US)

(21) Appl. No.: 17/070,003

(22) Filed: Oct. 14, 2020

(51) Int. Cl. B66B 1/34

(52) U.S. Cl. CPC B66B 1/3492; B66B 2201/212; B66B 1/3415

(57) ABSTRACT

A method of generating a floor height map for an elevator system having an elevator car traveling in a hoistway includes: accessing run group data, the run group data including information corresponding to a plurality of runs of an elevator car for a plurality of floor traversals by the elevator car; evaluating potential floor heights for at least one floor of the hoistway and potential floor travel sequences in response to the run group data; determining a likelihood of each combination of potential floor heights and potential floor travel sequences for the plurality of floor traversals; selecting potential floor heights and a potential floor travel sequence, as selected floor heights and a selected floor travel sequence, in response to the likelihood; generating the floor height map in response to the selected floor heights and the selected floor travel sequence.

### BACKGROUND

The embodiments herein relate to the field of conveyance systems, and specifically to a method and apparatus for mapping floor height in an elevator system.

Elevator systems often employ condition-based maintenance (CBM) processes in order to detect existing or potential maintenance items. Existing CBM processes may detect noise or vibration as the elevator car moves along a hoistway. Noise or vibration may also be measured as doors (e.g., landing door(s) and/or elevator car door(s)) open and close. It is beneficial to determine where the noise or vibration is occurring in the elevator system, so that maintenance personnel can more easily diagnose and resolve the maintenance item.

### BRIEF SUMMARY

According to an embodiment, a method of generating a floor height map for an elevator system having an elevator car traveling in a hoistway includes: accessing run group data, the run group data including information corresponding to a plurality of runs of an elevator car for a plurality of floor traversals by the elevator car; evaluating potential floor heights for at least one floor of the hoistway and potential floor travel sequences in response to the run group data; determining a likelihood of each combination of potential floor heights and potential floor travel sequences for the plurality of floor traversals; selecting potential floor heights and a potential floor travel sequence, as selected floor heights and a selected floor travel sequence, in response to the likelihood; generating the floor height map in response to the selected floor heights and the selected floor travel sequence.

In addition to one or more of the features described herein, or as an alternative, further embodiments may include wherein the run group data includes a number of downwards runs by the elevator car and a number of upwards runs by the elevator car.

In addition to one or more of the features described herein, or as an alternative, further embodiments may include wherein the run group data includes a position of the elevator car at an end of each run group.

In addition to one or more of the features described herein, or as an alternative, further embodiments may include wherein the position of the elevator car at the end of each run group includes an absolute position.

In addition to one or more of the features described herein, or as an alternative, further embodiments may include wherein the position of the elevator car at the end of each run group includes a relative position.

In addition to one or more of the features described herein, or as an alternative, further embodiments may include wherein the position of the elevator car at the end of each run group includes an absolute position and a relative position.

In addition to one or more of the features described herein, or as an alternative, further embodiments may include providing the floor height map to a maintenance system.

According to another embodiment an elevator system includes: an elevator car traveling in a hoistway; a sensing apparatus affixed to the elevator car, the sensor apparatus generating run data corresponding to travel of the elevator car from one floor to another floor; a remote system in communication with the sensing apparatus, the remote system configured to execute a process including: accessing run group data, the run group data including information corresponding to a plurality of runs of an elevator car for a plurality of floor traversals by the elevator car; evaluating potential floor heights for at least one floor of the hoistway and potential floor travel sequences in response to the run group data; determining a likelihood of each combination of potential floor heights and potential floor travel sequences for the plurality of floor traversals; selecting potential floor heights and a potential floor travel sequence, as selected floor heights and a selected floor travel sequence, in response to the likelihood; generating the floor height map in response to the selected floor heights and the selected floor travel sequence.

In addition to one or more of the features described herein, or as an alternative, further system embodiments may include wherein the run group data is generated by the remote system.

In addition to one or more of the features described herein, or as an alternative, further system embodiments may include wherein the run group data includes a number of downwards runs by the elevator car and a number of upwards runs by the elevator car.

In addition to one or more of the features described herein, or as an alternative, further system embodiments may include wherein the run group data includes a position of the elevator car at an end of each run group.

In addition to one or more of the features described herein, or as an alternative, further system embodiments may include wherein the position of the elevator car at the end of each run group includes an absolute position.

In addition to one or more of the features described herein, or as an alternative, further system embodiments may include wherein the position of the elevator car at the end of each run group includes a relative position.

In addition to one or more of the features described herein, or as an alternative, further system embodiments may include wherein the position of the elevator car at the end of each run group includes an absolute position and a relative position.

In addition to one or more of the features described herein, or as an alternative, further system embodiments may include wherein the remote system is further configured to provide the floor height map to a maintenance system.

According to another embodiment a computer program product embodied on a non-transitory computer readable medium, the computer program product including instructions that, when executed by a processor, cause the processor to perform operations including: accessing run group data, the run group data including information corresponding to a plurality of runs of an elevator car for a plurality of floor traversals by the elevator car; evaluating potential floor heights for at least one floor of the hoistway and potential floor travel sequences in response to the run group data; determining a likelihood of each combination of potential floor heights and potential floor travel sequences for the plurality of floor traversals; selecting potential floor heights and a potential floor travel sequence, as selected floor heights and a selected floor travel sequence, in response to the likelihood; generating the floor height map in response to the selected floor heights and the selected floor travel sequence.

Technical effects of embodiments of the present disclosure include the ability to map a height of landings in an elevator system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 is a schematic illustration of a sensor system for the elevator system of FIG. 1, in accordance with an embodiment of the disclosure;

FIG. 3 is a schematic illustration of the location of sensing apparatus of the sensor system of FIG. 2, in accordance with an embodiment of the disclosure;

FIG. 4 is a schematic illustration of a sensing apparatus of the sensor system of FIG. 2, in accordance with an embodiment of the disclosure; and

FIG. 5 is a schematic illustration of a remote system in accordance with an embodiment of the disclosure;

FIG. 6 depicts an example of elevator car runs; and

FIG. 7 is a flow chart of a method of mapping floor height, in accordance with an embodiment of the disclosure.

### DETAILED DESCRIPTION

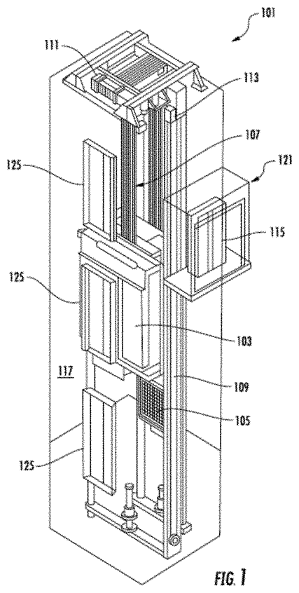

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., friction wheels or beam climbers). FIG. 1 is merely a non-limiting example presented for illustrative and explanatory purposes.

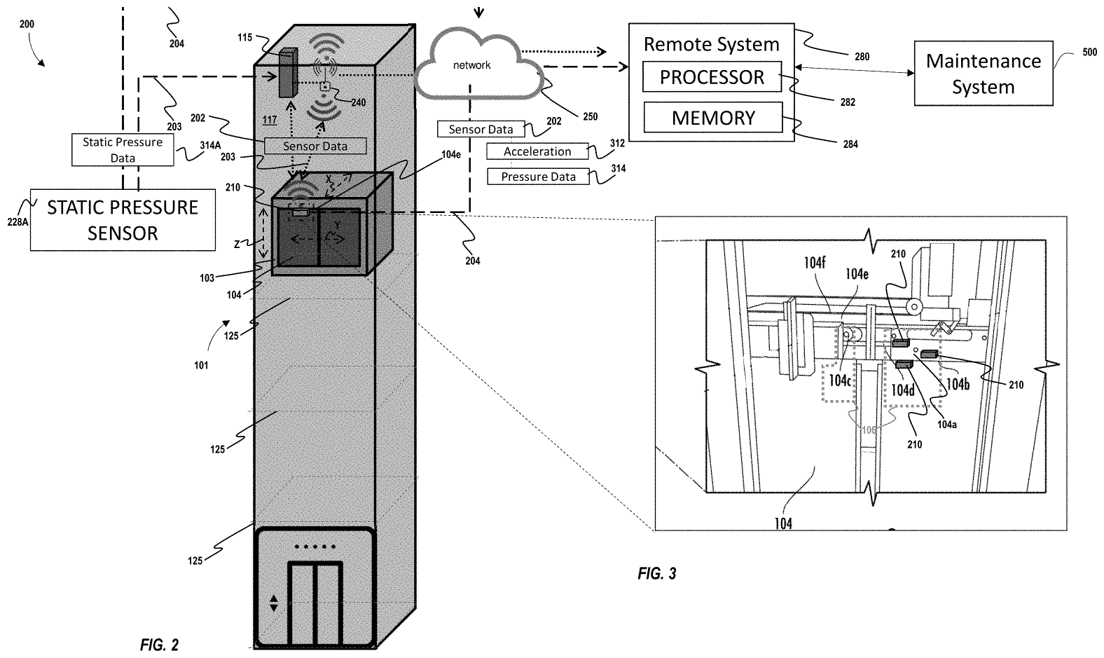

Referring now to FIG. 2, with continued referenced to FIG. 1, a view of a sensor system 200 including a sensing apparatus 210 is illustrated, according to an embodiment of the present disclosure. The sensing apparatus 210 is configured to detect sensor data 202 of the elevator car 103 and transmit the sensor data 202 to a remote system 280. Sensor data 202 may include but is not limited to pressure data 314, vibratory signatures (i.e., vibrations over a period of time) or accelerations 312 and derivatives or integrals of accelerations 312 of the elevator car 103, such as, for example, distance, velocity, jerk, jounce, snap . . . etc. The pressure data 314 may include atmospheric air pressure within the elevator hoistway 117. It should be appreciated that, although particular systems are separately defined in the schematic block diagrams, each or any of the systems may be otherwise combined or separated via hardware and/or software. For example, the sensing apparatus 210 may be a single sensor or may be multiple separate sensors that are interconnected.

In an embodiment, the sensing apparatus 210 is configured to transmit sensor data 202 that is raw and unprocessed to the controller 115 of the elevator system 101 for processing. In another embodiment, the sensing apparatus 210 is configured to process the sensor data 202 prior to transmitting the sensor data 202 to the controller 115 through a processing method, such as, for example, edge processing. In another embodiment, the sensing apparatus 210 is configured to transmit sensor data 202 that is raw and unprocessed to a remote system 280 for processing. In yet another embodiment, the sensing apparatus 210 is configured to process the sensor data 202 prior to transmitting the sensor data 202 to the remote system 280 through a processing method, such as, for example, filtering.

The processing of the sensor data 202 may reveal data, such as, for example, a number of elevator door openings/closings, elevator door time, vibrations, vibratory signatures, a number of elevator rides, elevator ride performance, elevator flight time, releveling events, rollbacks, elevator car 103 x, y acceleration at a position: (i.e., rail topology), elevator car 103 x, y vibration signatures at a position: (i.e., rail topology), door performance at a landing number, nudging event, vandalism events, emergency stops, etc.

The remote system 280 may be a computing device, such as, for example, a desktop, a server, a cloud based computer, and/or a cloud based artificial intelligence (AI) computing system. The remote system 280 may include a processor 282 and an associated memory 284 comprising computer-executable instructions that, when executed by the processor 282, cause the processor 282 to perform various operations. The processor 282 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 284 may be but is not limited to a random access memory (RAM), read only memory (ROM), or other electronic, optical, magnetic or any other computer readable medium. The remote system 280 includes a network connection to communicate with the elevator system 101 over network 250.

The sensing apparatus 210 is configured to transmit the sensor data 202 to the controller 115 or the remote system 280 via short-range wireless protocols 203 and/or long-range wireless protocols 204. Short-range wireless protocols 203 may include but are not limited to Bluetooth, BLE Wi-Fi, HaLow (801.11ah), zWave, ZigBee, or Wireless M-Bus. Using short-range wireless protocols 203, the sensing apparatus 210 is configured to transmit the sensor data 202 directly to the controller 115 or to a local gateway device 240 and the local gateway device 240 is configured to transmit the sensor data 202 to the remote system 280 through a network 250 or to the controller 115. The network 250 may be a wired network or a wireless network. Using long-range wireless protocols 204, the sensing apparatus 210 is configured to transmit the sensor data 202 to the remote system 280 through a network 250. Long-range wireless protocols 204 may include but are not limited to cellular, LTE (NB-IoT, CAT M1), LoRa, Satellite, Ingenu, or SigFox. Network 250 may employ both wireless and/or wired connectivity. For example, data from the sensing apparatus 210 may be transferred to local gateway device 240 using a wireless connection, which is then transfer to the remote system 280 over wired/wireless connections.

The sensing apparatus 210 may be configured to detect sensor data 202 including acceleration in any number of directions. In an embodiment, the sensing apparatus may detect sensor data 202 including accelerations 312 along three axis, an X axis, a Y axis, and a Z axis, as show in in FIG. 2. The X axis may be perpendicular to the doors 104 of the elevator car 103, as shown in FIG. 2. The Y axis may be parallel to the doors 104 of the elevator car 103, as shown in FIG. 2. The Z axis may be aligned vertically parallel with the elevator hoistway 117 and pull of gravity, as shown in FIG. 2. The acceleration data 312 may reveal vibratory signatures generated along the X-axis, the Y-axis, and the Z-axis.

The sensor system 200 includes a static pressure sensor 228A configured to detect static pressure data 314A, which includes a static atmospheric air pressure. The static pressure sensor 228A is located at a static or stationary location off of the elevator car 103. Thereby, a change in static atmospheric air pressure may be solely caused by the weather and not by movement of the elevator car 103.

The static pressure sensor 228A is configured to transmit the static pressure data 314A to the controller 115 or the remote system 280 via short-range wireless protocols 203 and/or long-range wireless protocols 204. Short-range wireless protocols 203 may include but are not limited to Bluetooth, Wi-Fi, HaLow (801.11ah), zWave, ZigBee, or Wireless M-Bus. Long-range wireless protocols 204 may include but are not limited to cellular, LTE (NB-IoT, CAT M1), LoRa, satellite, Ingenu, or SigFox. Using short-range wireless protocols 203, the static pressure sensor 228A is configured to transmit the static pressure data 314A directly to the controller 115 or to a local gateway device 240. The local gateway device 240 is configured to transmit the static pressure data 314A to the remote system 280 through a network 250. The network 250 may be a wired network (e.g., Internet) or a wireless network (e.g., cellular).

The remote system 280 may be in communication with a maintenance system 500. The maintenance system 500 may be a computing device, such as, for example, a desktop, a server, a cloud based computer, and/or a cloud based artificial intelligence (AI) computing system. The maintenance system 500 may be implemented using the same device implementing the remote system 280. The maintenance system 500 uses a floor height map derived from the remote system 280 to evaluate condition-based maintenance for the elevator system 101. The maintenance system 500 may also be in communication with the sensing apparatus 210, either through remote system 280 or directly through network 250. Data from the sensing apparatus 210 is communicated to the maintenance system 500. In this way, the maintenance system 500 can correlate data from the sensing apparatus 210 to the floor mapping from the remote system 280. For example, the maintenance system 500 may receive an indication of excessive door noise at an absolute position of 3.1 meters in the hoistway 117. The maintenance system 500 uses the floor height map from the remote system 280 to determine that the absolute position of 3.1 meters corresponds to floor 2 of the building. This allows maintenance personnel to be directed to the correct floor of the elevator system 101 for evaluation of the excessive noise.

FIG. 3 shows a possible installation location of the sensing apparatus 210 within the elevator system 101. The sensing apparatus 210 may include a magnet (not show) to removably attach to the elevator car 103. In the illustrated embodiment shown in FIG. 3, the sensing apparatus 210 may be installed on the door hanger 104a and/or the door 104 of the elevator system 101. It is understood that the sensing apparatus 210 may also be installed in other locations other than the door hanger 104a and the door 104 of the elevator system 101. It is also understood that multiple sensing apparatus 210 are illustrated in FIG. 3 to show various locations of the sensing apparatus 210 and the embodiments disclosed herein may include one or more sensing apparatus 210. In another embodiment, the sensing apparatus 210 may be attached to a door header 104e of a door 104 of the elevator car 103. In another embodiment, the sensing apparatus 210 may be located on a door header 104e proximate a top portion 104f of the elevator car 103. In another embodiment, the sensing apparatus 210 is installed elsewhere on the elevator car 103, such as, for example, directly on the door 104.

As shown in FIG. 3, the sensing apparatus 201 may be located on the elevator car 103 in the selected areas 106, as shown in FIG. 3. The doors 104 are operably connected to the door header 104e through a door hanger 104a located proximate a top portion 104b of the door 104. The door hanger 104a includes guide wheels 104c that allow the door 104 to slide open and close along a guide rail 104d on the door header 104e. Advantageously, the door hanger 104a is an easy to access area to attach the sensing apparatus 210 because the door hanger 104a is accessible when the elevator car 103 is at landing 125 and the elevator door 104 is open. Thus, installation of the sensing apparatus 210 is possible without taking special measures to take control over the elevator car 103. For example, the additional safety of an emergency door stop to hold the elevator door 104 open is not necessary as door 104 opening at landing 125 is a normal operation mode. The door hanger 104a also provides ample clearance for the sensing apparatus 210 during operation of the elevator car 103, such as, for example, door 104 opening and closing. Due to the mounting location of the sensing apparatus 210 on the door hanger 104a, the sensing apparatus 210 may detect open and close motions (i.e., acceleration) of the door 104 of the elevator car 103 and a door at the landing 125. Additionally, mounting the sensing apparatus 210 on the hanger 104a allows for recording of a ride quality of the elevator car 103.

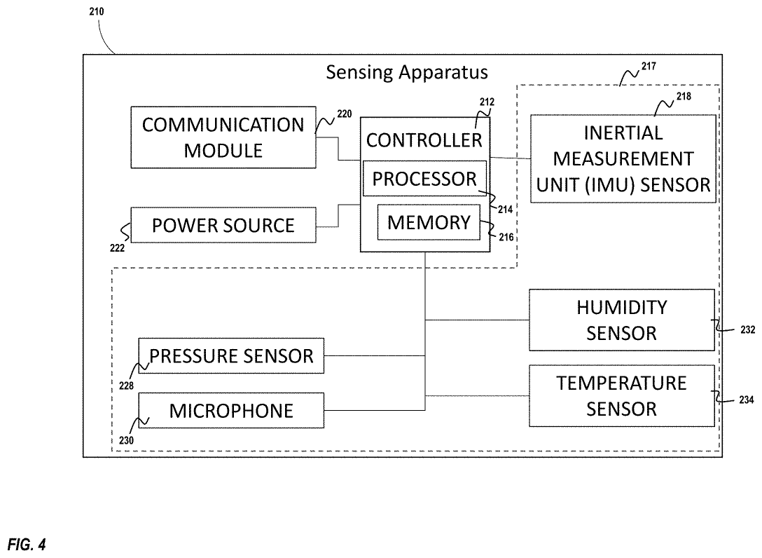

FIG. 4 illustrates a block diagram of the sensing apparatus 210 of the sensing system of FIGS. 2 and 3. It should be appreciated that, although particular systems are separately defined in the schematic block diagram of FIG. 4, each or any of the systems may be otherwise combined or separated via hardware and/or software. As shown in FIG. 4, the sensing apparatus 210 may include a controller 212, a plurality of sensors 217 in communication with the controller 212, a communication module 220 in communication with the controller 212, and a power source 222 electrically connected to the controller 212.

The plurality of sensors 217 includes an inertial measurement unit (IMU) sensor 218 (e.g., accelerometer) configured to detect sensor data 202 including accelerations 312 of the sensing apparatus 210 and the elevator car 103 when the sensing apparatus 210 is attached to the elevator car 103. The IMU sensor 218 may be a sensor, such as, for example, an accelerometer, a gyroscope, or a similar sensor known to one of skill in the art. The accelerations 312 detected by the IMU sensor 218 may include accelerations 312 as well as derivatives or integrals of accelerations, such as, for example, velocity, jerk, jounce, snap . . . etc. The IMU sensor 218 is in communication with the controller 212 of the sensing apparatus 210.

The plurality of sensors 217 includes a pressure sensor 228 is configured to detect sensor data 202 including pressure data 314, such as, for example, atmospheric air pressure within the elevator hoistway 117. The pressure sensor 228 may be a pressure altimeter or barometric altimeter in two non-limiting examples. The pressure sensor 228 may be in communication with the controller 212.

The plurality of sensors 217 may also include additional sensors including but not limited to a microphone 230, a humidity sensor 232, and a temperature sensor 234. The microphone 230 is configured to detect sensor data 202 including audible sound and sound levels. The microphone 230 may be in communication with the controller 212. The humidity sensor 232 is configured to detect sensor data 202 including humidity levels. The humidity sensor 232 may be in communication with the controller 212. The temperature sensor 234 is configured to detect sensor data 202 including temperature levels. The temperature sensor 234 may be in communication with the controller 212. Temperature data from temperature sensor 234 and/or humidity data from the humidity sensor 232 may be used to calibrate the pressure data received from the pressure sensor 228.

The controller 212 of the sensing apparatus 210 includes a processor 214 and an associated memory 216 comprising computer-executable instructions that, when executed by the processor 214, cause the processor 214 to perform various operations, such as, for example, pre-processing or processing the sensor data 202 collected by the IMU sensor 218, the pressure sensor 228, the microphone 230, the humidity sensor 232, and the temperature sensor 234. The processor 214 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 216 may be a storage device, such as, for example, a random access memory (RAM), read only memory (ROM), or other electronic, optical, magnetic or any other computer readable medium.

The power source 222 of the sensing apparatus 210 is configured to store and supply electrical power to the sensing apparatus 210. The power source 222 may include an energy storage system, such as, for example, a battery system, capacitor, or other energy storage system known to one of skill in the art. The power source 222 may also generate electrical power for the sensing apparatus 210. The power source 222 may also include an energy generation or electricity harvesting system, such as, for example synchronous generator, induction generator, or other type of electrical generator known to one of skill in the art.

The sensing apparatus 210 includes a communication module 220 configured to allow the controller 212 of the sensing apparatus 210 to communicate with the remote system 280, the local gateway device 240 and/or controller 115 through at least one of short-range wireless protocols 203 and long-range wireless protocols 204. The communication module 220 may be configured to communicate with the remote system 280 using short-range wireless protocols 203, such as, for example, Bluetooth, BLE, Wi-Fi, HaLow (801.11ah), Wireless M-Bus, zWave, ZigBee, or other short-range wireless protocol known to one of skill in the art. Using short-range wireless protocols 203, the communication module 220 is configured to transmit the sensor data 202 to a local gateway device 240 and the local gateway device 240 is configured to transmit the sensor data 202 to a remote system 280 through a network 250, as described above. The communication module 220 may be configured to communicate with the remote system 280 using long-range wireless protocols 204, such as for example, cellular, LTE (NB-IoT, CAT M1), LoRa, Ingenu, SigFox, Satellite, or other long-range wireless protocol known to one of skill in the art. Using long-range wireless protocols 204, the communication module 220 is configured to transmit the sensor data 202 to a remote system 280 through a network 250. In an embodiment, the short-range wireless protocol 203 is sub GHz Wireless M-Bus. In another embodiment, the long-range wireless protocol is SigFox. In another embodiment, the long-range wireless protocol is LTE NB-IoT or CAT M1 with 2G, 3G fallback.

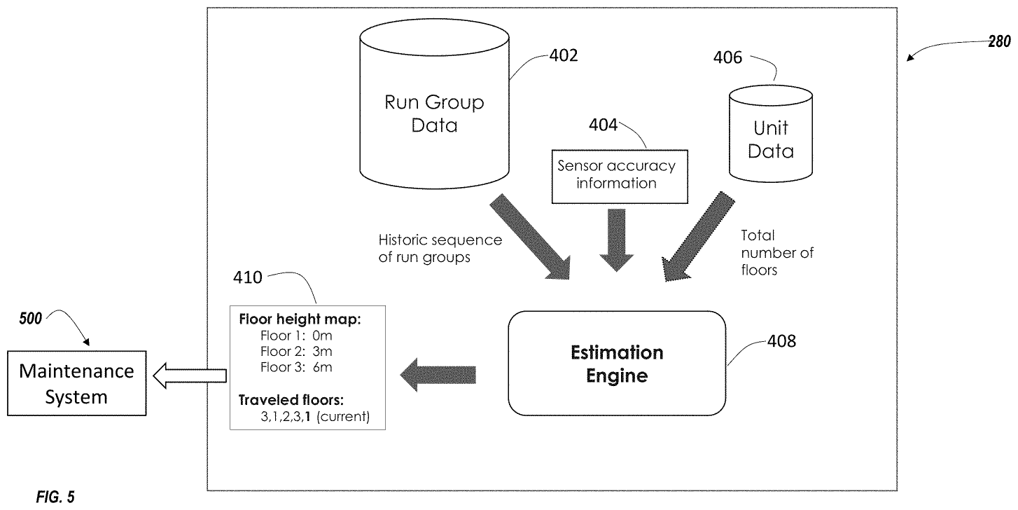

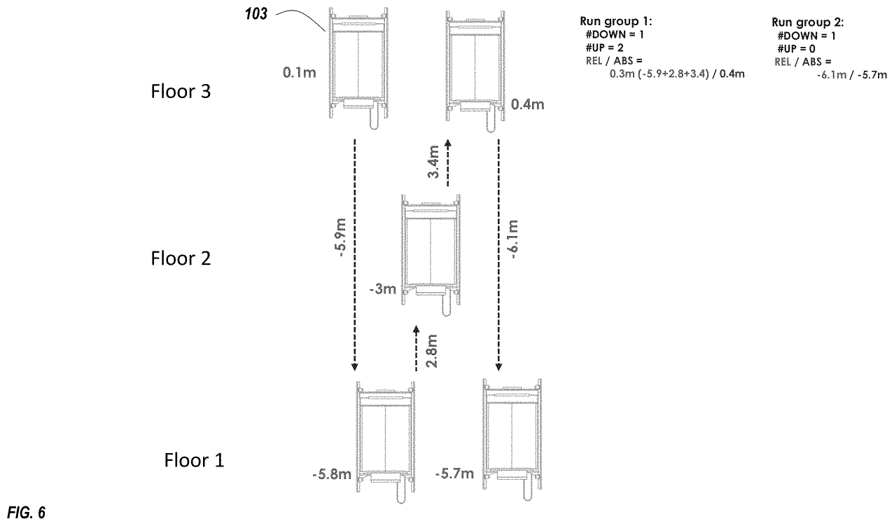

FIG. 5 depicts components of the remote system 280 in accordance with an embodiment of the disclosure. The remote system 280 stores run group data 402 which includes information corresponding to a plurality of runs of the elevator car 103. A run of the elevator car 103 corresponds to travel of the elevator car 103 from one floor (or landing) to another floor (or landing). Run data of one or more runs of the elevator car 103 may be collected into run group data. The run group data may include the number of downward runs, the number of upwards runs, and one or both of (i) the sum of the relative positions of each run and (ii) the final absolute position of the elevator car 103. The absolute position of the elevator car 103 may be determined by the pressure sensor 228 data. The relative position of the elevator car 103 may be determined from the IMU sensor 218 data. The relative position of the elevator car 103 is a distance travelled by the elevator car 103 from a starting position to a stopping position. As known in the art, acceleration data from the IMU sensor may be processed (e.g., integrated twice) to provide distance. The run group data 402 may be stored in memory 284 of the remote system 280.

Sensor accuracy information 404 provides data corresponding to measurement tolerance of one or more sensors of the sensor apparatus 210. The sensor accuracy information 404 may be represented as a plus or minus value to indicate a degree of measurement accuracy of one or more sensors of the sensor apparatus 210. The sensor accuracy information 404 may be stored in memory 284 of the remote system 280.

Unit data 406 represents information related to the building in which elevator car 103 travels. The unit data 406 may include a list of floors that the elevator car 103 can access. For example, a building may have 20 floors, but floors 3-7 are not accessed by the elevator car 103. The unit data 406 reflects that floors 3-7 are not visited by the elevator car 103, and is useful in mapping the height of elevator floors, as described further herein. The unit data 406 may be stored in memory 284 of the remote system 280.

The estimation engine 408 executes a floor height mapping process in order to determine a height of each floor (visitable by the elevator car 103) in the elevator system 101. The estimation engine 408 may be implemented by the processor 282 of the remote system 280. The estimation engine 408 processes run group data 402, which includes for each run group the number of downward runs, the number of upwards runs, and one or both of (i) the sum of the relative positions of each run of the run group and (ii) the final absolute position of the elevator car 103 at the end of the run group. Each run of the elevator car 103 will include a starting and ending absolute position and/or a relative position, indicating a distance traveled between the start position and the end position. The relative position at the end of a run group is determined by summing the relative travel of the elevator car 103 for each run of a run group.

From the run group data, the estimate engine 408 evaluates potential floor heights and potential floor travel sequences and selects floor heights and a floor travel sequence having a maximum likelihood of occurring based on the run group data. The selected floor heights and the selected floor travel sequence are used to derive the floor height map 410 which correlates floor number to height in the hoistway 117. The floor height map 410 is provided to the maintenance system 500. The maintenance system 500 uses the floor height map to determine at which floor a maintenance task is needed.

FIG. 6 depicts an example of elevator car 103 executing five runs, along with absolute position and relative position. The absolute position may be measured with respect to a reference datum in the hoistway 117. The relative position will have a sign corresponding to direction of travel (e.g., negative for downwards travel and positive for upwards travel). The relative position is measured from the immediately previous stopped location of the elevator car 103. In FIG. 6, the elevator car 103 is initially at rest at floor 3 with an absolute position of 0.1 m. The elevator car 103 travels to floor 1 and stops, which results in an absolute position of −5.8 m and a relative position of −5.9 m. The elevator car 103 travels to floor 2 and stops, which results in an absolute position of −3 m and a relative position of 2.8 m. The elevator car 103 travels to floor 3 and stops, which results in an absolute position of 0.4 m and a relative position of 3.4 m. The elevator car 103 travels to floor 1 and stops, which results in an absolute position of −5.7 m and a relative position of −6.1 m.

The run data (e.g., absolute position and/or relative position) for each run may be arranged into run group data. The run group data includes the number of downward runs, the number of upwards runs, and one or both of (i) the sum of the relative positions of each run and (ii) the final absolute position of the elevator car 103. In the example of FIG. 6, the first three runs are arranged in to run group 1 and the final run is arranged in run group 2.

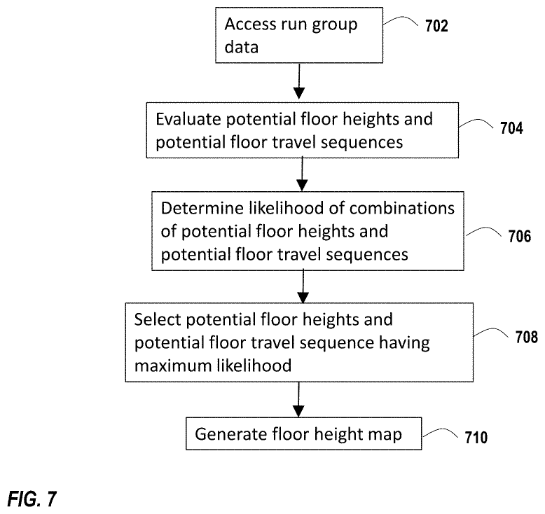

FIG. 7 is a flow chart of a method of mapping floor height performed by the estimation engine 408. At 702, the remote system 280 accesses the run group data 402. The run group data may be determined at the elevator system 101, for example, by the local gateway device 240 and then transferred to the remote system 280. Alternatively, run data from the sensing apparatus 210 may be transferred to the remote system 280, which then consolidates the run data into the run group data.

At 704, the estimation engine 408 evaluates potential floor heights and potential floor travel sequences in response to the run group data. Using the example from FIG. 6, the run data includes absolute positions of 0.1 m, −5.8 m, −3 m, 0.4 m, −5.7 m. The estimation engine 408 also determines that three floors were visited by the elevator car based on a priori data regarding the expected distance between floors. The relative position provides traveled distances as −5.9 m, 2.8 m, 3.4 m and −6.1 m, and directions as down, up, up, down.

At 706, the estimation engine 408 determines a likelihood of combinations of potential floor heights and potential floor travel sequences obtained from the run group data for the observed floor traversals. The estimation engine 408 searches through all possible floor travel sequences that make this possible, such as (3,1,2,3,1), (3,1,2,3,2), (2,1,2,3,2), etc., in a prioritized way. For each floor travel sequence, estimation engine 408 determines a likelihood that the elevator car traveled in that floor travel sequence. The estimation engine 408 will know the total number of visited floors during the period of time corresponding to the run group data. If the number of visited floors is not available, two options are considered. If the run group data covers a long period of time, the estimation engine 408 assumes that all the floors have been visited at least once. Otherwise, the estimation engine 408 can learn the number of visited floors by trying for num_floors=2, 3, 4, etc. until an acceptable learning error is achieved (e.g., set by some threshold).

At 708, the estimation engine 408 selects a floor heights and a floor travel sequence resulting in a maximum likelihood. In the example of FIG. 6, the estimation engine 408 would return a selected floor travel sequence of (3,1,2,3,1) with selected floor heights of (0, 2.9, 5.9).

At 710, the estimation engine generates the floor height map 410 based on the selected floor heights and the selected floor travel sequence. The floor height map correlates a floor number to a height in the hoistway 117. The floor height map may then be provided to the maintenance system 500 for CBM operations.

While the above description has described the flow process of FIG. 7 in a particular order, it should be appreciated that unless otherwise specifically required in the attached claims that the ordering of the steps may be varied.

As described above, embodiments can be in the form of processor-implemented processes and devices for practicing those processes, such as a processor in remote system 280. Embodiments can also be in the form of computer program code containing instructions embodied in tangible media, such as network cloud storage, SD cards, flash drives, floppy diskettes, CD ROMs, hard drives, or any other computer-readable storage medium. Embodiments can also be in the form of computer program code transmitted over some transmission medium, such as over electrical wiring or cabling, through fiber optics, or via electromagnetic radiation. When implemented on a general-purpose microprocessor, the computer program code configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of generating a floor height map for an elevator system having an elevator car traveling in a hoistway, the method comprising:
accessing run group data, the run group data including information corresponding to a plurality of runs of an elevator car for a plurality of floor traversals by the elevator car;
evaluating potential floor heights for at least one floor of the hoistway and potential floor travel sequences in response to the run group data;
determining a likelihood of each combination of potential floor heights and potential floor travel sequences for the plurality of floor traversals;
selecting potential floor heights and a potential floor travel sequence, as selected floor heights and a selected floor travel sequence, in response to the likelihood;
generating the floor height map in response to the selected floor heights and the selected floor travel sequence.

2. The method of claim 1 wherein the run group data includes a number of downwards runs by the elevator car and a number of upwards runs by the elevator car.

3. The method of claim 2 wherein the run group data includes a position of the elevator car at an end of each run group.

4. The method of claim 3 wherein the position of the elevator car at the end of each run group includes an absolute position.

5. The method of claim 3 wherein the position of the elevator car at the end of each run group includes a relative position.

6. The method of claim 3 wherein the position of the elevator car at the end of each run group includes an absolute position and a relative position.

7. The method of claim 1 further comprising providing the floor height map to a maintenance system.

8. An elevator system comprising:
an elevator car traveling in a hoistway;
a sensing apparatus affixed to the elevator car, the sensor apparatus generating run data corresponding to travel of the elevator car from one floor to another floor;
a remote system in communication with the sensing apparatus, the remote system configured to execute a process including:
accessing run group data, the run group data including information corresponding to a plurality of runs of an elevator car for a plurality of floor traversals by the elevator car;
evaluating potential floor heights for at least one floor of the hoistway and potential floor travel sequences in response to the run group data;
determining a likelihood of each combination of potential floor heights and potential floor travel sequences for the plurality of floor traversals;
selecting potential floor heights and a potential floor travel sequence, as selected floor heights and a selected floor travel sequence, in response to the likelihood;
generating the floor height map in response to the selected floor heights and the selected floor travel sequence.

10. The system of claim 8 wherein the run group data is generated by the remote system.

11. The system of claim 8 wherein the run group data includes a number of downwards runs by the elevator car and a number of upwards runs by the elevator car.

12. The system of claim 11 wherein the run group data includes a position of the elevator car at an end of each run group.

13. The system of claim 12 wherein the position of the elevator car at the end of each run group includes an absolute position.

14. The system of claim 12 wherein the position of the elevator car at the end of each run group includes a relative position.

15. The system of claim 12 wherein the position of the elevator car at the end of each run group includes an absolute position and a relative position.

16. The system of claim 8 wherein the remote system is further configured to provide the floor height map to a maintenance system.

17. A computer program product embodied on a non-transitory computer readable medium, the computer program product including instructions that, when executed by a processor, cause the processor to perform operations comprising:
accessing run group data, the run group data including information corresponding to a plurality of runs of an elevator car for a plurality of floor traversals by the elevator car;
evaluating potential floor heights for at least one floor of the hoistway and potential floor travel sequences in response to the run group data;
determining a likelihood of each combination of potential floor heights and potential floor travel sequences for the plurality of floor traversals;
selecting potential floor heights and a potential floor travel sequence, as selected floor heights and a selected floor travel sequence, in response to the likelihood;
generating the floor height map in response to the selected floor heights and the selected floor travel sequence.
